(19) United States
(12) Patent Application Publication
(10) Pub. No.: US 2009/0186252 A1
(43) Pub. Date: Jul. 23, 2009

(54) ORGANIC-INORGANIC COMPOSITE POLYMER ELECTROLYTE MEMBRANE FOR FUEL CELLS AND ITS PREPARATION METHOD

(76) Inventors: Jin-Soo Park, Daejeon (KR); Krishnan Palanichamy, Daejoen (KR); Chang-Soo Kim, Incheon (KR); Sung-Dae Yim, Daejeon (KR); Tae-Hyun Yang, Daejeon (KR); Gu-Gon Park, Daejeon (KR); Young-Gi Yoon, Daejeon (KR); Seok-Hee Park, Daejeon (KR); Min-Jin Kim, Daejeon (KR); Suk-Kee Um, Daejeon (KR); Sang-Phil Yu, Daejeon (KR); Wong-Yong Lee, Daejeon (KR)

Correspondence Address: MCDERMOTT WILL & EMERY LLP, 600 13TH STREET, N.W., WASHINGTON, DC, 20005-3096, US

(21) Appl. No.: 12/374,929

(22) PCT Filed: Jul. 25, 2007
(86) PCT No.: PCT/KR2007/003571

§ 371 Date: Jan. 23, 2009

(30) Foreign Application Priority Data
Jul. 25, 2006 (KR) 10-2006-0069916

(51) Int. Cl. H01M 8/10; C08J 5/20

(52) U.S. Cl. 429/33; 521/27

(57) ABSTRACT

The present invention relates to a preparing process an organic-inorganic composite polymer membrane for fuel cell by using sol-gel process. At this time, it is characterized in that when a sulfonated hydrocarbons polymer having ion conductivity is cast with film shape, sol-gel process which enables to distribute an inorganic matter having an excellent cation exchange and moisture holding capacity homogeneously is used. With homogeneous introduction of an inorganic matter into a polymer matrix by sol-gel process according to the present invention, it is possible to improve a phenomenon that an inorganic matter is partially concentrated at some position, thereby enabling to obtain an ion conducting organic-inorganic composite polymer membrane having an excellent ion conductivity.

### TECHNICAL FIELD

The present invention relates to preparation of an organic-inorganic composite polymer electrolyte membrane having an ion conductivity, and more particularly to inorganic particles having an excellent ion conductivity being introduced homogeneously with sol-gel process which contains an inorganic matter having an ion conductivity and effectively suppresses the said matter to be released toward out side, a composite polymer electrolyte membrane having an excellent ion conductivity containing the said inorganic particles, and preparing process thereof.

### BACKGROUND ART

Fuel cells are classified with Alkaline Fuel Cell (AFC), Phosphoric Acid Fuel Cell (PAFC), Molten Carbonate Fuel Cell (MCFC), Solid Oxide Fuel Cell (SOFC), Direct Methanol Fuel Cell (DMFC) and Polymer Electrolyte Membrane Fuel Cell (PEMFC) by a type of the used electrolyte. Among the said fuel cells of several types, the Polymer Electrolyte Membrane Fuel Cell and the Direct Methanol Fuel Cell have no risk such as corrosion or evaporation due to an electrolyte and make it possible to gain high current density per unit dimension to enhance an output of power prominently regard to the other cells and its operating temperature low since these cells use a polymer materials as an electrolyte so that it have been actively propelled for development of these cells in many country such as America, Japan and Europe and the like to use as a transportable power source for vehicles, a on-site power source for public building, and a small power source for electronic equipment. Furthermore, an ion conducting polymer electrolyte membrane is one of the most important core elements which decide its capacity and cost at the polymer electrolyte membrane fuel cell and the direct methanol fuel cell.

At the present day, it has been generally used a perfluorosulfonate ionomer membrane such as Nafion (trademark produced by DuPont Co.), Flemion (trademark produced by Asahi Glass Co.), Asiplex (trademark produced by Asahi Chemical Co.), Dow XUS (trademark produced by Dow Chemical Co.) and the like as a polymer electrolyte membrane, however there are much difficult matter for commercializing the said polymer fuel cells with power source for generating electricity because of its expensive cost.

As an expediency to remove the said difficult matter, it is employed an electrolyte membrane of fuel cells by casting an ion conducting polymer obtained from a sulfonation of the materials such as polyether ether ketone, polysulfone or polyimide whose price is relatively cheap and mechanical and thermal property is prominent. An organic-inorganic composite polymer electrolyte membrane can be produced by mixing hydrogen ion conducting inorganic matter into a matrix of sulfonated polymer electrolyte membrane to enhance ion conductivity (G. Alberti, M. Casciola, Composite membranes for medium-temperature PEM fuel cells, Annu. Rev. Mater. Res., Vol. 33, pp. 129-154, 2003).

Among the said prior art, it has been progressing the research for introducing the various hydrogen ion conducting inorganic matter by using a sulfonation of polyether ether ketone, and this kind of hydrogen ion conducting inorganic matter include zirconium phosphate sulfonphenylenphosphonate (B. Bonnet, D. J. Jones, J. Roziere, L. Tchicaya, G. Alberti, M. Casciola, L. Massinelli, B. Bauer, A. Peraio, E. Ramunni, Hybrid organic-inorganic membranes for a medium temperature fuel cell, J. New Mater. Electrochem. Syst. Vol. 3, pp. 87-92, 2000), heteropolyacid (S. M. Zaidi, S. D. Mikhailenko, G. P. Robertson, M. D. Guiver, S. Kaliaguine, Proton conducting composite membranes from polyether ether ketone and heteropolyacids for fuel cell applications, J. Membr. Sci., Vol. 173, pp. 17-34, 2000), boron phosphate (S. D. Mikhailenko, S. M. Zaidi, S. Kaliaguine, Sulfonated polyether ether ketone based composite polymer electrolyte membranes, Catal. Today Vol. 67, pp. 225-236, 2001; S. M. Zaidi, Preparation and characterization of composite membranes using blends of SPEEK/PBI with boron phosphate, Electrochim. Acta, Vol. 50, pp. 4771-4777, 2005) and the like. Such organic-inorganic composite polymer electrolyte membranes are produced by casting a solution obtained with mixing a solid of inorganic powder into a sulfonated polymer solution homogeneously. However, the organic-inorganic composite electrolyte membranes obtained from the above mentioned method do not have the desired physical and chemical property, physical intensity or electrochemical property due to poor adhesiveness, non-uniform dispersion and fin of the inorganic matter introduced into a polymer matrix (S. D. Mikhailenko, S. M. Zaidi, S. Kaliaguine, Sulfonated polyether ether ketone based composite polymer electrolyte membranes, Catal. Today Vol. 67, pp. 225-236, 2001).

### DISCLOSURE

### Technical Problem

Accordingly, the present invention has been made in view of the above-mentioned problems occurring in the prior art, and it is an object of the present invention to provide sol-gel process enabling uniform introduction of a hydrogen ion conducting inorganic matter into a polymer matrix and provide a polymer electrolyte membrane of film type by sulfonating hydrocarbons polymer whose price is relatively cheap and thermal and mechanical property is prominent.

It is another object of the present invention to provide the organic-inorganic composite polymer electrolyte membranes which are introduced a hydrogen ion conducting inorganic matter homogeneously by using the said sol-gel process and preparing method of the same.

### Technical Solution

To accomplish the above object, the present invention has features as followings.

The present invention is achieved by treating a polymer solution obtained by dissolving a sulfonated hydrocarbons polymer into the solvent containing a hydrogen ion conducting inorganic particles with so-gel process, wherein the said so-gel process includes the processes of agitating the said polymer solution under keeping at constant temperature, heating to 100° C. to 150° C. during 10 to 15 hours with a proper heating device, and then drying during 10 to 15 hours at the said temperature under condition of vacuum.

The said hydrogen ion conducting inorganic particles can be prepared through passing a precursor interchanged with the below materials to least one organic solvent selected from group consisted of n,n-dimethylacetamide (DMAc), dimethylformamide (DMF), dimethyl sulfoxide (DMSO), n-methyl-2-pyrolidone (NMP) in-situ.

Also, the said hydrogen ion conducting inorganic particles is more than one selected from group consisted of silica, alumina, zirconia, zeolite, titanium oxide, and its size is preferably 0.01 to 10 μm. Preferably, the said sulfonated hydrocarbons polymer may be prepared by sulfonating with at least one polymer selected from a group of polyether plastics consisted of polyether ether ketone, polyacetal, polyphenylen oxide, polysulfone, polyether sulfone, polyphenylene sulfide.

Also, there is characterized in that the said hydrogen ion conducting inorganic particles may be contained with range of between 10 and 40 parts of weight based on 100 parts of weight of the organic-inorganic composite polymer electrolyte membranes, and the said sulfonated hydrocarbons polymer may be contained with range of between 60 and 90 parts of weight based on 100 parts of weight of a hydrogen ion conducting inorganic particles.

According to another aspect of the present invention, the preparing process comprises the steps consisting in:

(a-1) pre-treating a hydrocarbons polymer;

(b-1) dissolving the polymer prepared with the above step (a-1) at the constant temperature with agitation into sulfuric acid;

(c-1) cooling a hydrocarbons polymer sulfonated by the above step (b-1) and then washing with precipitating it into a distilled water of low temperature;

(d-1) drying the washed sulfonated hydrocarbons polymer under vacuum;

(a-2) dissolving the said a sulfonated polymer into organic solvent containing a hydrogen ion conducting polymer, and then preparing a mixture by mixing thereto with a precursor to carry out a sol-gel process;

(b-2) agitating the mixture obtained from the above step (a-2) under keeping at the constant temperature;

(c-2) shaping a film by using the product obtained from the above step (b-2), and then obtaining an organic-inorganic composite polymer electrolyte membranes with dryness of the said film.

Wherein, there is characterized in that the said sulfonated hydrocarbons polymer may be prepared by sulfonating with at least one polymer selected from a group of polyether plastics consisted of polyether ether ketone, polyacetal, polyphenylen oxide, polysulfone, polyether sulfone, polyphenylene sulfide.

Also, it is preferable to carry out the said drying step of (d-1) at an oven kept at temperature of 60° C. during 12 hours, and then kept at an oven kept at temperature of 110° C. during 12 hours under vacuum state. The said organic solvent is consisted of at least one selected from a group consisted of n,n-dimethylacetamide (DMAc), dimethylformamide (DMF), dimethyl sulfoxide (DMSO), n-methyl-2-pyrolidone (NMP).

Additionally, in the said step to obtain the organic-inorganic composite polymer electrolyte membranes, a size of a polymer electrolyte membranes of film shape is preferably 20 to 150 μm. Drying process of the said step (c-2) is carried out at an oven kept at temperature of 60° C. during 12 hours, and then kept at an oven kept at temperature of 110° C. during 12 hours under vacuum state.

Also, the said pre-treating step is carried out by drying at 120° C. to 140° C. during above 24 hours to remove water content and organic matter.

### ADVANTAGEOUS EFFECTS

The organic-inorganic composite polymer electrolyte membranes according to the present invention enable a hydrogen ion conducting inorganic particles being carried by sol-gel process to be distributed homogeneously and effectively inhibit it to be leaked outside. Therefore, the present invention makes it possible to obtain the polymer electrolyte membranes whose thermal safety, electrochemical capacity and physical and chemical safety are prominent due to an excellent interaction of uniformly introduced inorganic particles by using the said process within a sulfonated hydrocarbons polymer matrix.

### DESCRIPTION OF DRAWINGS

FIG. 1 is a cross section view that illustrates the photograph of organic-inorganic composite polymer electrolyte membranes produced by example 1 of the present invention measured by a Scanning Electron Microscope (SEM).

FIG. 2 is a view that illustrates result of FT-IR analyses of the sulfonated polymer electrolyte membranes and the organic-inorganic composite polymer electrolyte membranes produced by example 1 of the present invention.

FIG. 3 is a view that illustrates result of XRD analyses of the sulfonated polymer electrolyte membranes and the organic-inorganic composite polymer electrolyte membranes produced by example 1 of the present invention.

FIG. 4 is a view that illustrates result of DSC analyses of the sulfonated polymer electrolyte membranes and the organic-inorganic composite polymer electrolyte membranes produced by example 1 of the present invention.

FIG. 5 is a view that illustrates result of TGA analyses of the sulfonated polymer electrolyte membranes and the organic-inorganic composite polymer electrolyte membranes produced by example 1 of the present invention.

FIG. 6 is a view that illustrates experimental result of hydrogen ion conductivity measured with temperature of the sulfonated polymer electrolyte membranes and the organic-inorganic composite polymer electrolyte membranes according to example 1 and 2 of the present invention.

FIG. 7 is a view that illustrates result of an aquation safety test measured with temperature of the sulfonated polymer electrolyte membranes and the organic-inorganic composite polymer electrolyte membranes according to example 1 and 3 of the present invention.

### BEST MODE

The preferred embodiment according to the present invention will be described at below in details with reference to the attached drawings,

To achieve the said first objection, tripropylborate (C₉H₂₁O₃B) and phosphoric acid (H₃PO₄) are used as a precursor for preparing boron phosphate according to the present invention. Boron phosphate is represented with the below formula 1.

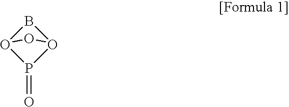

Wherein, boron phosphate is compound which phosphate (P) atom of orthophosphate and boron (B) atom construct coordinate covalent bond of tetrahedron together with oxygen. This crystalline solid is un-soluble in aqueous phase, has capability that hold water content up to 300 degree since partially dissociated water is presented on the surface of boron phosphate with the forms of B—OH bond isolated together with phosphate (P) atom and boron (B) atom, P—OH bond, general P—OH bond, and OH group of hydrogen bond and the like (J. B. Moffat, E. E. Chao, B. Nott, Temperature programmed desorption studies on boron phosphate, J. Colloid Interface Sci., Vol. 67, pp. 240-246, 1978). With the said function, it is reported that hydrogen ion conductivity of boron phosphate is reached up to maximum 0.048 Scm⁻¹ when rate B/P is 0.80 (S. D. Mikhailenko, J. Zaidi, S. Kaliaguine, Electrical conductivity of boron orthophosphate in presence of water, J. Chem. Soc., Faraday Trans., Vol. 94, pp. 1613-1618, 1998).

More precisely, the sol-gel process to prepare boron phosphate is carried out by mixing tripropylborate and phosphoric acid as precursor like below reacting equation 1, and then heating at constant temperature of 120° C. during about 10 minutes and stirring, thereby being formed boron phosphate of crystalline solid as main product and propanol as by-product. At that time, the by-product, propanol is evaporated by heating at constant temperature of 120° C. so that only boron phosphate which is main product is remained.

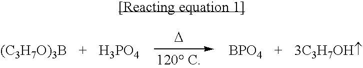

The said second objection of the present invention is achieved by obtaining the organic-inorganic composite polymer electrolyte membranes through steps of (a-1) pre-treating a hydrocarbons polymer whose price is relatively cheap and thermal and mechanical property is prominent; (b-1) dissolving the polymer prepared with the above step (a-1) at the constant temperature with agitation into sulfuric acid; (c-1) cooling a polymer sulfonated by the above step (b-1) and then washing with precipitating it into a distilled water of low temperature; (d-1) drying the washed sulfonated hydrocarbons polymer under vacuum; (a-2) dissolving the said a sulfonated polymer into organic solvent containing a hydrogen ion conducting polymer, and then preparing a mixture by mixing thereto with a precursor to carry out a sol-gel process; (b-2) agitating the mixture obtained from the above step (a-2) under keeping at the constant temperature; (c-2) shaping a film by using the product obtained from the above step (b-2), and then obtaining an organic-inorganic composite polymer electrolyte membranes with dryness of the said film.

In the organic-inorganic composite polymer electrolyte membranes according to the present invention, the hydrogen ion conducting inorganic particles may be preferably contained with range of between 10 and 40 parts of weight based on 100 parts of weight of the polymer electrolyte membranes, and the ion conducting polymer may be preferably contained with range of between 60 and 90 parts of weight based on 100 parts of weight of the polymer electrolyte membranes. The said hydrogen ion conducting inorganic matter is boron phosphate produced by a sol-gel process, an ion conducting polymer is at least one selected from a group consisted of a sulfonated polyethers plastics.

Preferably, the organic-inorganic composite polymer electrolyte membranes of the present invention is also that the crystalline particles of boron phosphate are introduced at a matrix of a ion conducting polymer membranes by a sol-gel process with three dimension homogeneously to make its introduced total thickness to 30 to 150 μm.

In the above preparing process, the said hydrocarbons polymer of step (a-1) may be at least one polymer selected from a group of polyether plastics consisted of polyether ether ketone, polyacetal, polyphenylen oxide, polysulfone, polyether sulfone, polyphenylene sulfide such as chemical formula 2˜7 respectively, and the pre-treating step thereof is preferably carried out by maintaining at a constant temperature of 130° C. during above 24 hours to remove water content and organic matter. And, a step (b-1) which progress sulfonation of a polymer use a solution of 95% sulfuric acid for agitation into sulfuric acid of a hydrocarbons polymer, and is carried out by feeding a nitrogen gas constantly into a reaction bath kept at a constant temperature of 50° C. First above all, a concentration of a polymer solution is preferably adjusted to about 5% with weight ratio, while a solution of sulfuric acid is constantly charged into a reaction bath with small portion under state of agitation.

The said step (c-1) is preferably carried out by cooling temperature to 10° C. after agitation during the determined time and terminating a reaction with precipitation of reactant into distilled water cooled with ice. And then, the sulfonated polymer that reaction is terminated is washed with distilled water. Preferably, it is repeatedly washed to when pH value of distilled water after washing reach to neutral state. And, drying process of the said step (d-1) is preferably carried out by drying the washed sulfonated polymer at an oven kept at temperature of 60° C. during 12 hours, and then drying at an oven kept at temperature of 110° C. during 12 hours under vacuum state.

And, in the case of preparation of the mixture at the above step (a-2), it is preferable that a prepared sulfonated polyethers polymer is dissolved in a specific organic solvent selected from groups of organic solvents and then tripropylborate and phosphoric acid as a precursor are mixed hereto with mole ratio of 1:1.

In the case of agitation of the mixture at the above step (b-2), it is preferable that phosphoric acid is firstly mixed to a polymer solution into a reaction tank kept with a constant temperature of 120° C. while charging a nitrogen gas continuously and a mixture is stirred during 10 minutes, and then tripropylborate is mixed to the said mixture and the resultant mixture is further stirred during 10 minutes.

In the case of obtainment of an organic-inorganic composite polymer electrolyte membrane at the above step (c-2), it is preferable that the stirred resultant is cast and dried at an oven kept with 120° C. during 12 hours and then further dried at an oven kept with the same temperature under vacuum condition during 12 hours.

According to the present invention, an organic-inorganic composite polymer electrolyte membrane may be prepared by sol-gel process which enables a hydrogen ion conducting inorganic particles to be introduced homogeneously in a process casting an ion conducting sulfonated polymer.

While the present invention has been described with reference to the particular illustrative examples, it is not to be restricted by the examples but only by the appended claims.

### Example 1

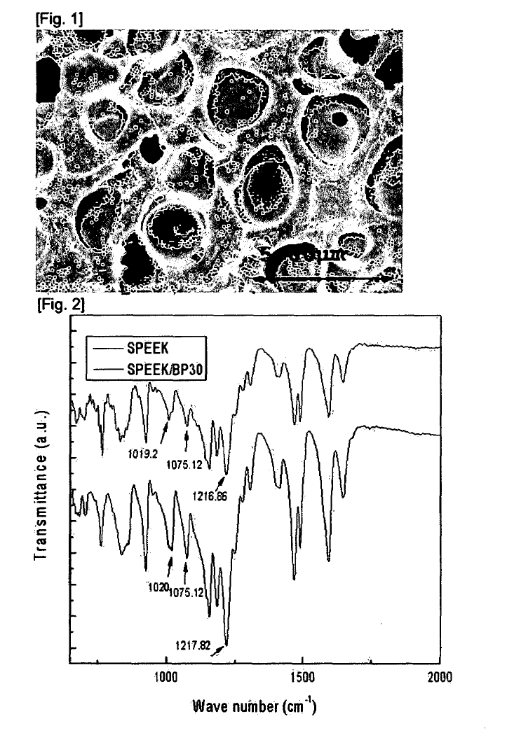

1.19, 2.67, 4.57 and 7.11 g of tripropylborate and 0.62, 1.4, 2.38 and 3.7 g of 85% phosphoric acid are added to 6 g of 10% weight ratio concentration sulfonated polyether ether ketone polymer solution dissolved in dimethylacetamide solvent, and then followed ultrasonic agitation during 1 hour and mechanic agitation during 6 hours. The said mixture is cast and dried at an oven kept with 120° C. during 12 hours and then further dried at an oven kept with the same temperature under vacuum condition during 12 hours to give boron phosphate/sulfonated polyether ether ketone composite polymer electrolyte having 10, 20, 30 and 40% weight ratio concentration respectively. The prepared film is analyzed by using SEM, FT-IR, XRD, DSC and TGA, the result of analysis is represented at FIGS. 1, 2, 3, 4 and 5.

With reference to the SEM photograph of FIG. 1, we can observe that the size of particles of boron phosphate being formed in the composite polymer electrolyte film prepared by example 1 is about 2 μm and distributed very homogeneously.

With reference to FIG. 2, we can also see that, in case of sulfonated polyether ether ketone electrolyte film, the bands of 1020.15, 1075.12, 1217.82 cm⁻¹ are all characteristic peak of sulfone group so that confirm that sulfone groups are fixed at the main chain of polyether ether ketone of example 1. And, among these peaks, two peaks, 1020.15 and 1217.82 are transferred to 1019.2 and 1216.86 cm⁻¹ from a FT-IR spectrum of composite electrolyte membranes containing 30% weight ratio conc. of boron phosphate due to a formation of —OH group which is bound to an inner surface of boron phosphate. Therefore, from this result, we can confirm that particles of boron phosphate are interacting with a group of sulfonic acid within a polymer matrix.

FIG. 3 represents result of XRD analyses. From this result, we can confirm that a sulfonated polyether ether ketone electrolyte membranes is semi crystalline polymer which show a peak of crystal type corresponding to (1 1 0), (1 1 1), (2 0 0) and (2 1 1) within a range of 20˜30° of 2θ. We can also see that an intensity of this peak of crystal type is reduced being compared with an increase of a weight ratio concentration of boron phosphate. It shows an effect according to an introduction of boron phosphate.

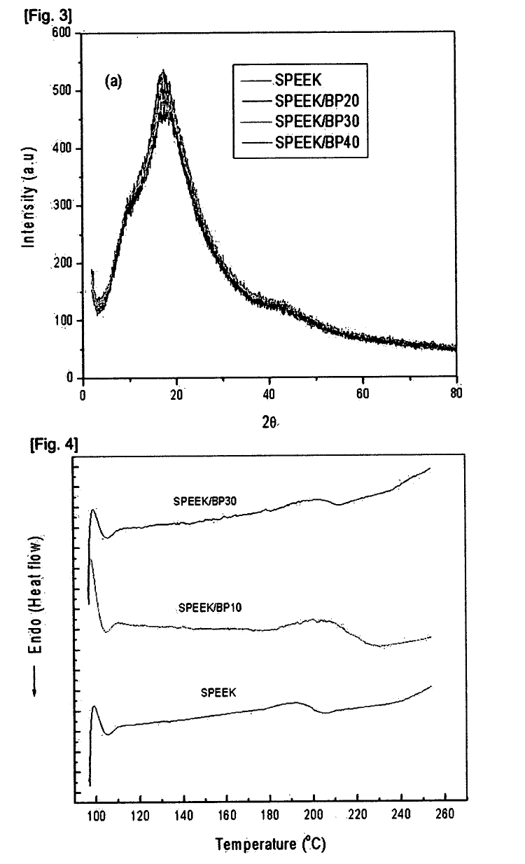

FIG. 4 illustrates result of DSC analyses of a sulfonated polyether ether ketone electrolyte membrane and a composite electrolyte membrane introduced boron phosphate. From this result, we can see that a glass transition temperature of a sulfonated polyether ether ketone electrolyte membrane is about 205° C. We can also confirm that, contrast to the above result, a glass transition temperature of a composite polymer electrolyte membrane having 10 and 30% weight ratio conc. of boron phosphate show respectively 213 and 208° C. to improve a thermal safety. It is higher value than a sulfonated polyether ether ketone electrolyte membrane which does not have boron phosphate, and this reason is that segmentation movements of polymers are restricted with an existence of hydrophilic boron phosphate and an action of hydrogen bond with sulfone groups.

FIG. 5 illustrates result of TGA analyses, a weight reduction of a sulfonated polyether ether ketone electrolyte membrane is progressed at three areas, and it is due to a reduction of water content of sulfonic acid group at temperature range of 150˜300° C., a degradation of sulfonic acid group at temperature range of 300˜450° C., and a degradation of polymer chain at temperature range of above 450° C. A weight reduction of a composite polymer electrolyte membrane at temperature range of 150˜300° C. is more than a sulfonated polyether ether ketone electrolyte membrane, and it is due to an excess amount of moisture which is excited in a composite polymer electrolyte membrane by adding boron phosphate which has higher holding capacity of moisture. From this result, we can confirm that beginning temperature for degrading a sulfonic acid group of a composite polymer electrolyte membrane is about 305˜315° C. which is higher than that of a sulfonated polyether ether ketone electrolyte membrane, and it is correspond to the above result of DSC analyses, thereby getting result that a thermal safety of a composite polymer electrolyte membrane becomes to be good.

### Example 2

To measure hydrogen ion conductivity for an invented electrolyte membrane, 4-electrolyte system measuring device that has been generally used is used and a resistance is measured by an impedance spectroscopy method. And, the above devise is positioned into a temperature-controllable chamber to change temperature and then hydrogen ion conductivity according to temperature is measured.

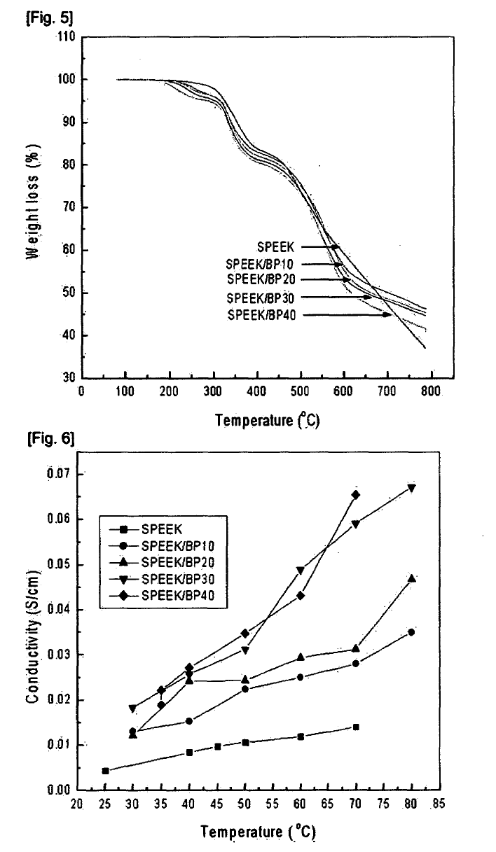

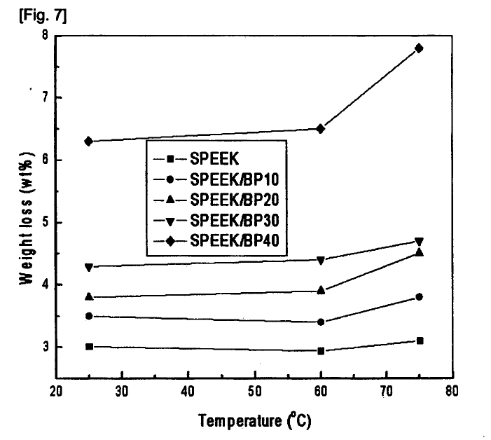

FIG. 6 is a view that represents result of hydrogen ion conductivity according to temperature of a sulfonated polyether ether ketone electrolyte membrane and a boron phosphate composite polymer electrolyte membrane which is measured with a device for measuring hydrogen ion conductivity at a state of 100% relative humidity. We can confirm that a composite polymer electrolyte membrane has higher hydrogen ion conductivity than a sulfonated polyether ether ketone electrolyte membrane at almost of all temperature range, and especially hydrogen ion conductivity of a composite polymer electrolyte membrane that has 30 and 40% weight ratio concentration of boron phosphate is improves about 6 times regard to a sulfonated polyether ether ketone electrolyte membrane.

### Example 3

The invented electrolyte membrane is dipped into distilled water having various temperatures and maintained at this condition during 240 hours to search degree for release of boron phosphate particles introduced into polymer matrix homogeneously with sol-gel process.

We can confirm a constant weight reduction at temperature range of 25˜70° C. except a composite polymer electrolyte membrane that has 40% weight ratio concentration of boron phosphate and its weight reduction is below 5% with totality. It is considered that this weight reduction is happened by non-dried organic solvent or water-soluble impurity, and we can see that it is due to water-soluble impurity from a fact that its weight reduction is increased if concentration of boron phosphate is increased. Therefore, it is demonstrated that inorganic particles have an excellent safety for hydration with sol-gel process since releasing phenomenon of boron phosphate particles did not detected even under the condition of aqueous solution of high temperature during long time.

1. An organic-inorganic composite polymer electrolyte membranes, characterized in that it is prepared by treating a polymer solution obtained by dissolving a sulfonated hydrocarbons polymer into the solvent containing a hydrogen ion conducting inorganic particles with so-gel process, wherein the said so-gel process includes the processes of agitating the said polymer solution under keeping at constant temperature, heating to 100° C. to 150° C. during 10 to 15 hours with a proper heating device, and then drying during 10 to 15 hours at the said temperature under condition of vacuum.

2. An organic-inorganic composite polymer electrolyte membranes according to claim 1, characterized in that the said hydrogen ion conducting inorganic particles is prepared through passing a precursor interchanged with the below materials to least one organic solvent selected from group consisted of n,n-dimethylacetamide (DMAc), dimethylformamide (DMF), dimethyl sulfoxide (DMSO), n-methyl-2-pyrolidone (NMP) in-situ.

3. An organic-inorganic composite polymer electrolyte membranes according to claim 1, characterized in that the said hydrogen ion conducting inorganic particles is more than one selected from group consisted of silica, alumina, zirconia, zeolite, titanium oxide, and its size is 0.01 to 10 μm.

4. An organic-inorganic composite polymer electrolyte membranes according to claim 1, characterized in that the said sulfonated hydrocarbons polymer is one sulfonated with at least one polymer selected from a group of polyether plastics consisted of polyether ether ketone, polyacetal, polyphenylen oxide, polysulfone, polyether sulfone, polyphenylene sulfide.

5. An organic-inorganic composite polymer electrolyte membranes according to claim 1, characterized in that the said hydrogen ion conducting inorganic particles is contained with range of between 10 and 40 parts of weight based on 100 parts of weight of an organic-inorganic composite polymer electrolyte membranes, and the said sulfonated hydrocarbons polymer is contained with range of between 60 and 90 parts of weight based on 100 parts of weight of a hydrogen ion conducting inorganic particles.

6. A preparing process of organic-inorganic composite polymer electrolyte membranes, characterized in that it comprises the steps consisting in:
(a-1) pre-treating a hydrocarbons polymer;
(b-1) dissolving the polymer prepared with the above step (a-1) at the constant temperature with agitation into sulfuric acid;
(c-1) cooling a hydrocarbons polymer sulfonated by the above step (b-1) and then washing with precipitating it into a distilled water of low temperature;
(d-1) drying the washed sulfonated hydrocarbons polymer under vacuum;
(a-2) dissolving the said a sulfonated polymer into organic solvent containing a hydrogen ion conducting polymer, and then preparing a mixture by mixing thereto with a precursor to carry out a sol-gel process;
(b-2) agitating the mixture obtained from the above step (a-2) under keeping at the constant temperature;
(c-2) shaping a film by using the product obtained from the above step (b-2), and then obtaining an organic-inorganic composite polymer electrolyte membranes with dryness of the said film.

7. A preparing process of organic-inorganic composite polymer electrolyte membranes according to claim 6, characterized in that the said sulfonated hydrocarbons polymer is one sulfonated with at least one polymer selected from a group of polyether plastics consisted of polyether ether ketone, polyacetal, polyphenylen oxide, polysulfone, polyether sulfone, polyphenylene sulfide.

8. A preparing process of organic-inorganic composite polymer electrolyte membranes according to claim 6, characterized in that the said dryness of step (d-1) is carried at an oven kept at temperature of 60° C. during 12 hours, and then carried at an oven kept at temperature of 110° C. during 12 hours under vacuum state.

9. A preparing process of organic-inorganic composite polymer electrolyte membranes according to claim 6, characterized in that the said organic solvent is consisted of at least one selected from a group consisted of n,n-dimethylacetamide (DMAc), dimethylformamide (DMF), dimethyl sulfoxide (DMSO), n-methyl-2-pyrolidone (NMP).

10. A preparing process of organic-inorganic composite polymer electrolyte membranes according to claim 6, characterized in that, in the said step to obtain the organic-inorganic composite polymer electrolyte membranes, a size of a polymer electrolyte membranes of film shape is 20 to 150 μm.

11. A preparing process of organic-inorganic composite polymer electrolyte membranes according to claim 7, characterized in that dryness of the said step (c-2) is carried out at an oven kept at temperature of 60° C. during 12 hours, and then carried at an oven kept at temperature of 110° C. during 12 hours under vacuum state.

12. A preparing process of organic-inorganic composite polymer electrolyte membranes according to claim 6, characterized in that the said pre-treating step is carried out by drying at 120 to 140° C. during above 24 hours to remove water content and organic matter.
